(19) United States
(12) Patent Application Publication
(10) Pub. No.: US 2002/0077128 A1
(43) Pub. Date: Jun. 20, 2002

(54) Method and apparatus in a network for advising and placing a calling party on hold/delay until call completion

(76) Inventors: Steve Okun, Toronto (CA); Paul Michael Brennan, Toronto (CA)

Correspondence Address: Garlick & Harrison, P.O. Box 670007, Dallas, TX, 75367, US

(21) Appl. No.: 09/742,047

(22) Filed: Dec. 20, 2000

(51) Int. Cl. H04Q 7/20

(52) U.S. Cl. 455/458; 455/414; 455/567

(57) ABSTRACT

A communication system constructed according to the present invention provides a method and apparatus for causing a message to be played to a calling party to indicate that the called party will be taking the call shortly. In each embodiment, a called party depresses a select key or button in a specified manner to indicate that the message should be played to the calling party. The method may be performed by anyone of an SS7 or other IN network, a wireless network, a mobile station or a wireline phone. According to the type of phone, differing embodiments of the methods performed by the communication network may be realized. In the case of a mobile station, the entire method may be performed by it in one embodiment of the invention. Alternatively, if the phone is a wireline phone, the method may be performed solely by the wireline telephone network. In one embodiment of the present invention, the call is connected as normal but the message is played to advise the calling party that the called party will be taking the call shortly. In other embodiments, either the call is not completed until the called party indicates a readiness to take the call, or alternatively, the call is connected but placed on hold or simulated hold by muting one or more of the phone microphone and speaker until the called party indicates a readiness to take the call.

### BACKGROUND

1. Technical Field

The present invention relates generally to communication systems, and more particularly, to a call feature in a communication system.

2. Related Art

Cellular wireless communication systems are generally known in the art to facilitate wireless communications within respective service coverage areas. Such wireless communication systems include a “network infrastructure” that facilitates the wireless communications with mobile stations operating within a service coverage area. The network infrastructure typically includes a plurality of base stations dispersed throughout the service coverage area, each of which supports wireless communications within a respective cell (or set of sectors). The base stations couple to base station controllers (BSCs), with each BSC serving a plurality of base stations. Each BSC couples to a mobile switching center (MSC) that also couples to the PSTN, the Internet and/or to other MSCs.

A wireless mobile station operating within the service coverage area communicates with one or more of the base stations. The base stations route the communications to the MSC via a serving BSC. The MSC routes the communications to another subscribing wireless unit via a BSC/base station path (which may be the same BSC/base station path when the communications are with another subscribing unit serviced by the same base station) or via the PSTN/Internet/other network to terminating destination.

Various operating standards have been developed to standardize wireless communications. The wireless communication operating standards include, for example, the Advanced Mobile Phone Service (AMPS) standards, the Global Standards for Mobility (GSM), the Code Division Multiple Access (CDMA) and the Time Division Multiple Access (TDMA) standards. A standard that is employed in North America for interconnectivity of MSCs is the IS-41 standard. These operating standards set forth the technical requirements that facilitate compatible operation between equipment of differing vendors.

In a cellular wireless communication system, each MSC is operated by a particular service provider and services communications over a fairly large geographic area. A large number of mobile stations are serviced by this MSC. Each MSC serves as a home or “originating MSC” for a number of mobile stations. The mobile stations are assigned a permanent telephone number that, when routed via the PSTN or other wireline communication network including the Signaling System Number 7 (SS7) network, reaches the originating MSC. The originating MSC then performs call routing in an attempt to deliver the call to the mobile station. As part of call routing, the originating MSC accesses the Home Location Register (HLR) servicing the mobile station. The HLR provides the identity of a MSC currently serving the mobile station (the “serving MSC”).

If the mobile station is operating with the coverage area of a base station supported by the originating MSC, the originating MSC is also the serving MSC. In such case, the originating MSC initiates a page to the mobile station, the mobile station responds to the page, and the call is completed. However, if the mobile station is not being served by the originating MSC, but instead is being served by another MSC, a serving MSC, inter MSC operation is initiated. In such case, the originating MSC sends a locate request to a HLR servicing the mobile station. In response, the HLR sends a route request to the serving MSC. Subsequently, the call is routed through the serving MSC to the mobile station. Such operation is often referred to as call termination while “roaming.”

In wireline networks, including SS7 networks, very little call setup logic is formed within the end point telephone. One reason for this design is that networks are made to be backwards compatible with older phone designs that have few capabilities besides auto redial. Moreover, because wireline network phones are not mobile, telephone numbers are assigned to locations and not to the phones themselves. Thus, a serving network has no need to verify location. All operations are performed in relation to the subscriber services assigned to a phone number at a particular location. Even in more advanced SS7 networks that comprise a signaling network as well as a trunking network for carrying the calls, the SS7 network only monitors a phone line for “off hook” indications and for the depression of keys on a phone keypad. The phone network then interprets the off hook or key pad indications to determine a response or to connect the call.

One common problem that is observable on a daily basis is that of a telephone ringing at a time that the ringing as well as the conversation would be disturbing to others. By way of example, mobile stations routinely ring in restaurants. At home, wireline phones often ring while the family is watching the television whereby a conversation of any duration would be disturbing.

Currently, whenever a phone rings at an inopportune time, one common remedy is to take the call, engage in enough of a conversation to exchange courtesies and to advise the calling party to hold. One attempted solution to this problem includes allowing the called party, especially a called party being called on his mobile phone, to depress a button or switch to turn off the ringer. One problem with this solution, however, is that the calling party does not know that the called party will be taking the call shortly. If the called party is not able to take the call quickly, the calling party may hang up, or, alternatively, may be transferred into voice mail. Thus, even if the called party is able to minimize the disturbance to others, by turning off the ringer, he is not able to deliver a message to the calling party to advise him to wait for the called party to take the call without increasing the amount of disturbance to others. Thus, there is a need in the art for a communication system in which the disturbance to others may be minimized while a called party moves to a location wherein the call may be taken.

### SUMMARY OF THE INVENTION

Thus, to overcome the shortcomings of the prior systems, among other shortcomings, a communication system constructed according to the present invention enables a called party to depress a specified digit or otherwise activate a solution to prompt the system to generate a voice message or text message to the calling party to advise the calling party that the called party will be picking up the call shortly. Thus, the called party is able to rapidly respond in a way that minimizes how much others are disturbed yet in a manner so as not to risk losing the incoming caller for failure to answer.

One embodiment of the present invention comprises a wireless communication system that includes an originating MSC, a home location register (HLR), a serving MSC and supporting infrastructure for each MSC. Such supporting infrastructure includes a plurality of base station controllers (BSC) and a plurality of base stations. The base stations support wireless communications within respective cells to service mobile stations operating in the cells.

When a call is received by the originating MSC intended for the mobile station, the originating MSC sends a locate request to the mobile station's HLR. The HLR then sends a route request to the serving MSC, such route request including the identity of a serving MSC to enable the originating MSC to complete the call to the mobile station.

Once the serving MSC generates call set up signals to the mobile station, the serving MSC monitors the response of the mobile station to determine if the mobile station called party depressed a select key or button on the mobile station to indicate that the MSC is to hold the call and to prompt an integrated voice response unit to play a select voice message to advise the calling party that the called party will be taking the call shortly. Thereafter, upon receiving an indication from the mobile station that the called party is ready to take the call, the MSC completes the call.

In an alternate embodiment of the invention, the inventive feature is self-contained within the mobile station. More specifically, the mobile station allows the call to be completed. Approximately at the same time, the mobile station mutes the microphone to prevent the called party from hearing any ongoing discussions and generates a stored voice message to inform the calling party that the called party will be taking the call shortly.

In yet another embodiment of the invention, the inventive feature is formed within an SS7 or other PSTN network. Here, a network, e.g., Signal Transfer Point (STP) monitors the receipt of an off hook indication followed by the depression of a select key or button on the phone. Upon determining that the select key or button has been depressed, the SCP keeps the call on hold and prompts an IVR to play a select message to advise the calling party that the called party will be taking the call shortly. This particular implementation may be made with a plurality of different types of phone systems. For example, in a multi-line phone, if a called party is on a first line when a call is being received on a second line, the called party may readily depress a select key or button or otherwise active the inventive feature to cause the system to automatically generate the message to the calling party without required the called party to interrupt his call on the first phone line. In the case where the called party is on a cordless phone, the system operation is the same. That the called party system operation occurs between the handset and its supporting base is immaterial for the purposes of the present invention. Here, the called party depresses the select key or button or otherwise activates the inventive feature. His selection is transmitted to the base of the phone wherein it is relayed to the phone network for further response according to the inventive methods described herein.

Similar to the cordless phone, the invention may be implemented in private wireless networks. By way of example, if a call is delivered through a commercial wireless network to a private network that includes its own wireless network, the invention herein may be adapted to work throughout the different wireless networks. In this particular example, call setup signals are delivered from the commercial wireless network or the PSTN (including SS7 networks) to the private network. The call setup signals are then forwarded to the called party phone of the private network. There, the called party may depress the select key or button or otherwise activate the inventive feature. In this particular example, the called party response is forwarded through the private network back into the wireless or PSTN network that originally delivered the call setup signals to the private network.

For each of the above embodiments, the invention may thus be implemented in differing types of networks. The invention thus includes the embodiment wherein the called party has a phone with only one voice line but also has a signaling line wherein he may be advised of the incoming call through the signaling line. Alternatively, wherein the called party has multiple lines, the invention includes his being advised either through any one of the signaling lines or a second voice line if the called party is one a first voice line.

In yet another embodiment of the invention, a response may be in the form of a text message. For example, if a calling party terminal ID is one that belongs to a text message capable group of terminals, the invention includes, under certain circumstances, a text response advising the calling party that the called party will be taking the call shortly. This particular embodiment can include, for instance, examining a subscriber profile stored within an HLR to determine whether a text message or voice message is preferred for those calling parties that are capable of receiving both. In the case where a calling party is capable of only one type, then the invention includes merely sending a response in the appropriate format that can be deciphered by the calling party.

As yet another aspect of the present invention, a calling party may find himself on hold indefinitely because the called party did not respond to the call promptly as was promised by the text or voice message that was system generated to the calling party. In short, the calling party may find himself in a type of “electronic jail”. Thus, one embodiment of the present invention includes offering the calling party a chance to proceed to voice mail whenever he or she desires to stop waiting and to leave a message. For example, this embodiment not only includes advising the calling party of a sequence of steps to take to leave a message, but also monitoring the phone line to determine when the calling party has selected the option of leaving a voice mail message and, responsive thereto, activating a voice mail service to take a voice mail message. For example, the response may include transferring the calling party to the called party's voice mail box within a voice mail system. As an alternative aspect to this embodiment, the invention includes automatically sending the calling party to voice mail if the called party has not taken the call within a select period of time, e.g., thirty seconds.

Other solutions to the “electronic jail” scenario include, automatically re-alerting or otherwise reminding the called party after a select period of time (e.g., twenty or thirty seconds). The reminder may be in the form of a unique beep, tone or vibration if the phone is actively in use. Along these lines, a calling party may be given an option to request that the called party be alerted again. The option may be given along with the initial system generated message or it may be automatically be given to the called party after a specified amount of time has elapsed since the original message was played to the calling party.

In yet another embodiment of the present invention, the inventive feature may be implemented in the case of teleconferencing or video phones. For example, if a called party is conducting a call on a video phone, and he receives an indication of a call being received, he may activate the system in any defined manner, to generate a text or voice message to the calling party to advise the calling party that the called party will be taking the call shortly.

Other aspects of the present invention will become apparent with further reference to the drawings and specification that follow.

### BRIEF DESCRIPTION OF THE DRAWINGS

A better understanding of the present invention can be obtained when the following detailed description of the preferred embodiment is considered in conjunction with the following drawings, in which:

FIGS. 1A and 1B are system diagrams illustrating generally the structure of a wireless communication system constructed according to the present invention serving a plurality of mobile stations 112, 113, and 126 and of an intelligent network constructed according to the present invention.

FIG. 2 is a message flow diagram illustrating the flow of messages among an originating mobile switching center, a home location register, a serving mobile switching center, a base station controller, a base station and a mobile station according to the present invention.

FIG. 3 is a flow chart illustrating a method in a network server for completing a call according to an embodiment of the present invention.

FIG. 4 is a flow chart illustrating a method in a network server for completing a call according to an embodiment of the present invention.

FIG. 5 is a flow chart illustrating a method in a mobile station for receiving a call and for causing a message to be played to the calling party indicating that the call will be answered shortly according to one embodiment of the present invention.

FIG. 6 is a flow chart illustrating a method in a mobile station for receiving a call and for causing a message to be played to the calling party indicating that the call will be answered shortly according to one embodiment of the present invention.

FIG. 7 is a flow chart illustrating a method in a called party phone for receiving a call and for causing a message to be played to the calling party indicating that the call will be answered shortly according to one embodiment of the present invention.

FIG. 8 is a functional block diagram of a mobile station formed according to the present invention.

FIG. 9 is a functional block diagram of a mobile switching center formed according to one embodiment of the present invention.

### DETAILED DESCRIPTION OF THE DRAWINGS

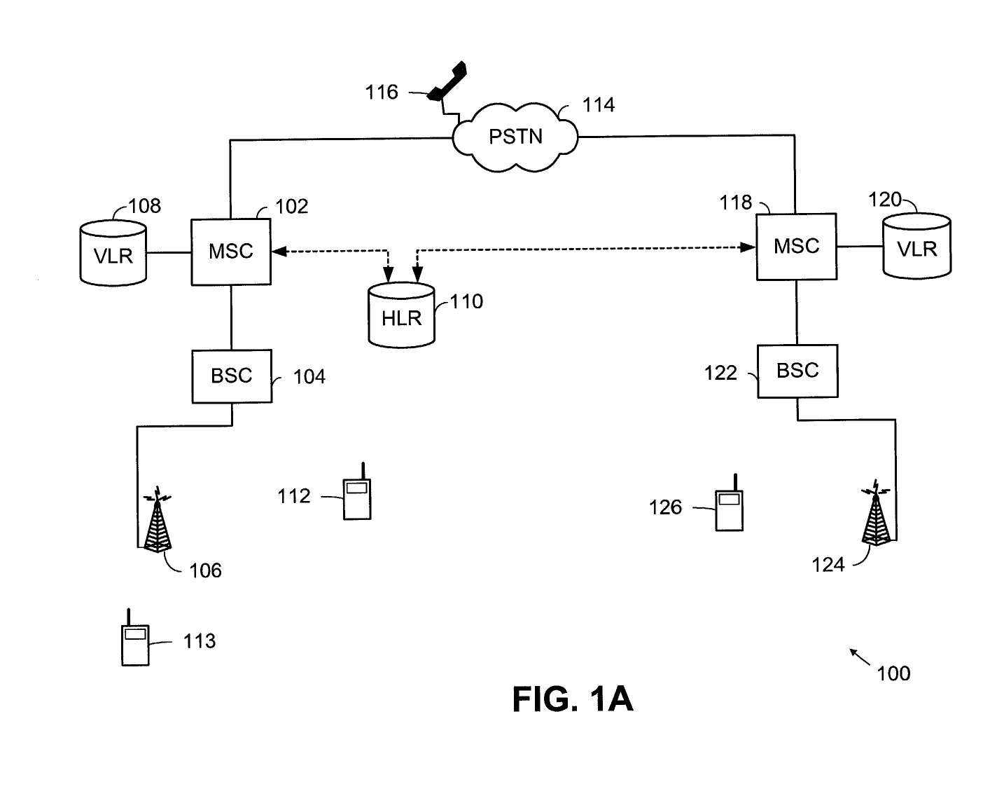

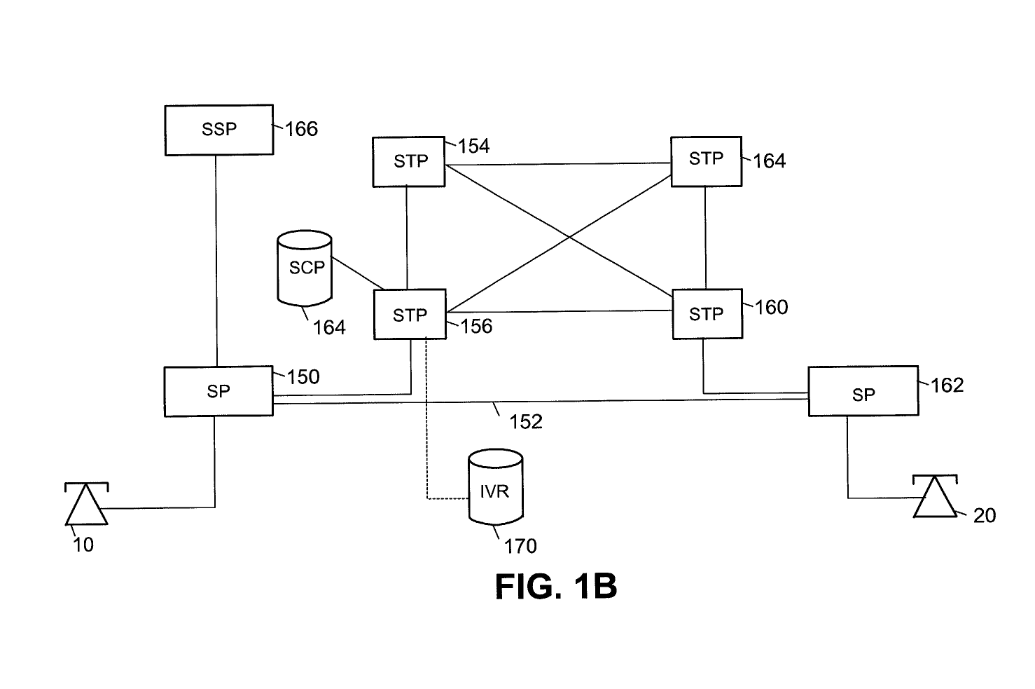

FIGS. 1A and 1B are system diagrams illustrating generally the structure of a wireless communication system constructed according to the present invention serving a plurality of mobile stations 112, 113, and 126 and of an intelligent network constructed according to the present invention. The wireless communication system 100 of FIG. 1A includes mobile switching centers (MSCs) 102 and 118. Coupled to each MSC 102 and 118 is at least one base station controller (BSC). For example, BSC 104 is coupled to MSC 102 while BSC 122 is coupled to MSC 118. Finally, at least one base station couples to each BSC. As shown, base station 106 couples to BSC 104 while base station 124 couples to BSC 122. The construction of cellular based wireless communication systems is generally known. Thus, the structure of such cellular wireless communication systems will not be discussed other than to explain the teachings of the present invention. However, in a typical cellular wireless communication system, a plurality of base stations couple to each BSC and a plurality of BSCs couple to each MSC.

Each of the MSCs 102 and 118 is serviced by a visitor location register (VLR) 108 and 120, respectively. Further, each of the MSCs 102 and 118 couples to a home location register (HLR) 110 which stores subscriber information. The construction of VLRs and HLRs is also generally known. Thus, the operation of the VLRs and HLRs will not be discussed herein except as it applies to operation according to the present invention. A signaling path between the MSCs 102 and 118 and the HLR 110 is shown as a dotted line while the traffic path between the MSCs 102 and 118 and the PSTN 114 is shown as a solid line. Communications between the MSCs 102 and 118 and the HLR may be compliant with the IS-41 standard promulgated for North American intersystem operations.

Each of the MSCs 102 and 118 also couples to the public switched telephone network (PSTN) 114. PSTN 114 may comprise a traditional network or a newer generation network such an SS7 type of intelligent network. The MSCs 102 and 118 may also couple to other communication networks as well, such as the Internet. The wireless communication system 100 services calls between terminals, e.g., 116, coupled to the PSTN 114 and mobile stations, e.g., 112, 113 and 126. In an example of such call servicing, a call is placed at the terminal 112 coupled to the PSTN 114 and completed to the mobile station 112 serviced by base station 112.

The wireless communication system 100 also services calls between mobile stations 112, 113 and 126 serviced by the wireless communication system 100. For example, mobile station 112 may initiate a call to mobile station 126. In such case, the wireless communication system 100 routes the call via base station 106, BSC 104, MSC 102, the PSTN 114, MSC 118, BSC 122 and base station 124. In another example, mobile station 113 initiates a call to mobile station 112. In such case, the wireless communication system 100 routes the call via base station 106, BSC 104, MSC 102, BSC 104 and base station 106. Thus, in the latter case, as opposed to the former example, MSC 102 services the call. In the former case, MSC 102 and MSC 118 service the call.

In an operation according to the present invention, MSC 102 is the originating MSC for mobile station 126. In such case, a call intended for the mobile station 126 initiated by terminal 116 is routed by the PSTN 114 to the MSC 102. Upon receipt of the call, the MSC 102 sends a locate request to the HLR 110 (which serves the mobile station 126 that is currently roaming in the service area of MSC 118).

In one example of the present invention, mobile station 112 initiates a call to mobile station 126. When initiating the call to mobile station 126, the mobile station 112 sends a request to setup the call to its serving MSC 102. The MSC 102 sends a locate request to the HLR 110. The HLR 110 then sends a route request to the MSC 102 that serves mobile station 112. Then, based upon called party reaction, the call is completed or the called party is temporarily placed on hold, or, alternatively, the connection is established and the calling party waits until the called party is ready to take the call.

The inventive processes may be modified to work with a plurality of different types of phone systems. For example, in a multi-line phone, if a called party is on a first line when a call is being received on a second line, the called party may readily depress a select key or button or otherwise active the inventive feature to cause the system to automatically generate the message to the calling party without required the called party to interrupt his call on the first phone line. In the case where the called party is on cordless phone, the system operation is the same. That the called party system operation occurs between the handset and its supporting base is immaterial for the purposes of the present invention. Here, the called party depresses the select key or button or otherwise activates the inventive feature. His selection is transmitted to the base of the phone wherein it is relayed to the phone network for further response according to the inventive methods described herein.

Similar to the cordless phone, the invention may be implemented in private wireless networks. By way of example, if a call is delivered through a commercial wireless network to a private network that includes its own wireless network, the invention herein may be adapted to work throughout the different wireless networks. In this particular example, call setup signals are delivered from the commercial wireless network or the PSTN (including SS7 networks) to the private network. The call setup signals are then forwarded to the called party phone of the private network. There, the called party may depress the select key or button or otherwise activate the inventive feature. In this particular example, the called party response is forwarded through the private network back into the wireless or PSTN network that originally delivered the call setup signals to the private network.

For each of the above embodiments, the invention may thus be implemented in differing types of networks. The invention thus includes the embodiment wherein the called party has a phone with only one voice line but also has a signaling line wherein he may be advised of the incoming call through the signaling line. Alternatively, wherein the called party has multiple lines, the invention includes his being advised either through any one of the signaling lines or a second voice line if the called party is one a first voice line.

In yet another embodiment of the invention, a response may be in the form of a text message. For example, if a calling party terminal ID is one that belongs to a text message capable group of terminals, the invention includes, under certain circumstances, a text response advising the calling party that the called party will be taking the call shortly. This particular embodiment can include, for instance, examining a subscriber profile stored within an HLR to determine whether a text message or voice message is preferred for those calling parties that are capable of receiving both. In the case where a calling party is capable of only one type, then the invention includes merely sending a response in the appropriate format that can be deciphered by the calling party.

As yet another aspect of the present invention, a calling party may find himself on hold indefinitely because the called party did not respond to the call promptly as was promised by the text or voice message that was system generated to the calling party. In short, the calling party may find himself in a type of “electronic jail”. Thus, one embodiment of the present invention includes offering the calling party a chance to proceed to voice mail whenever he or she desires to stop waiting and to leave a message. For example, this embodiment not only includes advising the calling party of a sequence of steps to take to leave a message, but also monitoring the phone line to determine when the calling party has selected the option of leaving a voice mail message and, responsive thereto, activating a voice mail service to take a voice mail message. For example, the response may include transferring the calling party to the called party's voice mail box within a voice mail system. As an alternative aspect to this embodiment, the invention includes automatically sending the calling party to voice mail if the called party has not taken the call within a select period of time, e.g., thirty seconds.

Other solutions to the “electronic jail” scenario include, automatically re-alerting or otherwise reminding the called party after a select period of time (e.g., twenty or thirty seconds). The reminder may be in the form of a unique beep, tone or vibration if the phone is actively in use. Along these lines, a calling party may be given an option to request that the called party be alerted again. The option may be given along with the initial system generated message or it may be automatically be given to the called party after a specified amount of time has elapsed since the original message was played to the calling party.

In yet another embodiment of the present invention, the inventive feature may be implemented in the case of teleconferencing or video phones. For example, if a called party is conducting a call on a video phone, and he receives an indication of a call being received, he may activate the system in any defined manner, to generate a text or voice message to the calling party to advise the calling party that the called party will be taking the call shortly.

FIG. 1B is an intelligent network that forms a signaling network and a trunking network for carrying the data and voice communications. Generally, the operation of intelligent networks is well known. Accordingly, the explanation herein focuses on the differences in the inventive network from common networks. More specifically, the IN network of FIG. 1B is formed to set up a call over the call signaling network and then, upon ringing the called party phone, to place the calling party on hold if the called party responds to the call by depressing a select button or key on the called party phone. Additionally, upon receive an indication that the called party has depressed the select key or button, the network of FIG. 1B is formed to prompt an IVR coupled thereto to play a select message to advise the calling party that the called party will be taking the call shortly.

More specifically, the functional block diagram of the IN of FIG. 1B includes a traditional monolithic switch coupled to route calls and to provide subscriber features and call management features to the called or calling parties or to both. A telephone 10 is coupled to a Signaling Point (SP) 150 that is for establishing a communication link (voice/data communication link) with a destination SP for delivery to the called party phone. For exemplary purposes, the destination SP is SP 162. The destination SP 162, in turn, connects the call to called party phone 20. SP 150 and SP 162 are coupled directly by a trunk 152. Trunk 152 is a line that physically couples and carries conversations and data from SP to SP. It should be understood, of course, that a communication link might comprise three or more SPs wherein a plurality of trunks would be used to create a communication link from calling party phone 10 to called party phone 20.

SP 150 is also coupled to a Service Switching Point (SSP) 162 and to a Signal Transfer Point (STP) 156. STP 156, in turn, is coupled to STP 160 as well as STPs 154 and 164. STP 156 also is coupled to a Service Control Point (SCP 164). An STP is a SP that runs SS7 Transaction Capabilities Application Part (TCAP) for the IN of FIG. 1B. It is capable of supporting service contral point (SCP) database operations, halting call progress and other operations. It can run in end offices, tandems, or access tandems. The STP runs the SS7's Message Transfer Part (MTP) and the Signaling Connection Control Part (SCCP). The STP only interfaces with SS7 links and does not interface with voice or data links.

The SCP is also a SP that provides data base support operations to another SCP or SSP. In operation, when calling party 10 dials the digits to place a call to called party 20, the SP 150 communicates with STP 156 that in turn communicates with SCP 164 to obtain routing information for the call. Thus SCP 164 returns the specific control and routing information to SP 150, via a signaling gateway to direct it to establish a trunk 152 with SP 162. Without the query to SCP 164, SP 150 does not know that called party is connected to SP 162. Thus, the query is necessary to determine what trunk line should be selected for routing the call.

The signaling messages that are routed and performed by STP 156 are, therefore, a critically important part of setting up a call. Accordingly, as may be seen, STP 156 also is coupled to STPs 124, 128, and 120. The network of STPs enables ultimate signal message routing in the event of a failure of a communication link.

In the present invention, when SP 162 receives an indication from phone 20 that the called party has depressed the select key or button, SP communicates with STP 160 to cause it to prompt an IVR such as IVR 170 to play a select message to the calling party to advise it that the called party will be taking the call shortly. In one embodiment of the invention, only an IVR message is played. In another embodiment of the invention, SP 162 holds the trunk 152 for the call as if connected but it does not transmit communication signals, e.g., voice, between the parties until it receives an indication from the called party phone that the called party is ready to take the call.

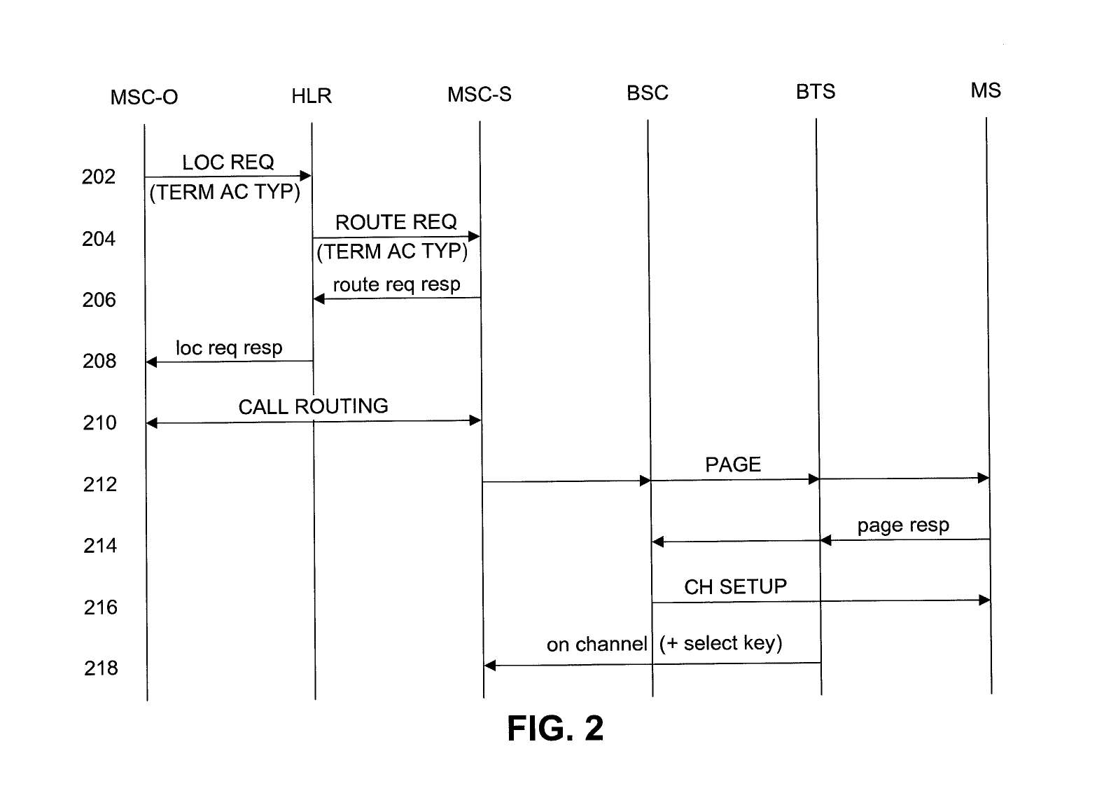

FIG. 2 is a message flow diagram illustrating the flow of messages among an originating mobile switching center, a home location register, a serving mobile switching center, a base station controller, a base station and a mobile station according to the present invention. At 202, the originating MSC has received a request to terminate a call to a mobile station based upon a call request. In response, the origination MSC sends a locate request to a serving HLR as shown at 204. As is generally known, the last known location of the mobile station is kept in the HLR and accessed in response to the locate request. This access determines the identity of the serving MSC.

In response, as shown at 206, the serving MSC responds to the HLR with a route request response. The HLR then sends a locate request response to the originating MSC at 208, such locate request response identifying the serving MSC to the originating MSC.

At 210, the originating MSC and the serving MSC perform call routing to service the call. The serving MSC then sends a page to the mobile station via at least one BSC and at least one base station transceiving subsystem (BTS) at 212. At 214, the mobile station responds to the page with a page response. Such page response is relayed via a servicing BTS to a servicing BSC. The servicing BSC then coordinates the allocation and setup of a channel to the mobile station at 216. Subsequently, the servicing BTS sends an on channel message to the serving MSC via the servicing BSC at 218.

Responsive to receiving the Channel Setup signaling at 216, the mobile station produces an alert for the called party. The alert may be in the form of a beep, a ringing tone, a flashing light or a mechanical response such as vibration. If the called party depresses a select key or button then the “on channel” signaling includes an indication of the same to prompt the serving MSC to prompt an IVR to generate a message for the calling party to advise that the called party will be taking the call shortly. If the called party merely depresses any key or button such as the talk button, then the call processing is as normal. Specifically, the “on channel” response does not include an indication that the called party depressed the select key or button.

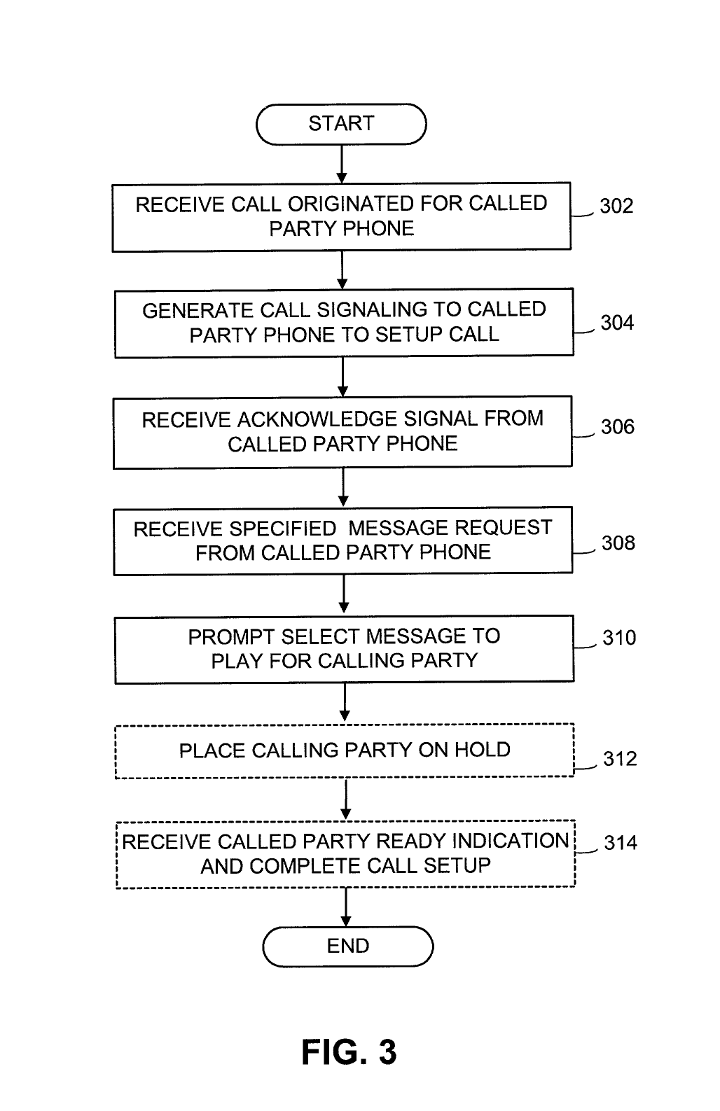

FIG. 3 is a flow chart illustrating a method in a network server for completing a call according to an embodiment of the present invention. In the described embodiment, the call server may be a serving MSC. Alternatively, however, the call server may be an SP, an STP or an SCP of an IN or SS7 network.

Initially, the call server receives a call that was originated for a called party phone, e.g., a mobile station (step 302). The serving MSC then generates call signaling to the called party phone to setup the call (step 304). The call signaling may be in the form of a page request for a mobile station or in the form of a ringing tone for a wireline phone that is part of a PSTN. Thereafter, the call server receives an acknowledge signal from the called party phone (step 306). If the called party phone is a wireline phone, the acknowledge signal may be in the form of an “off hook” indication. After, or as a part, of receiving the acknowledge signaling from the called party phone, the call server receives a specified message request from the called party phone.

The specified message request can be delivered in a plurality of ways. For example, it may be received as a DTMF tone generated by the called party phone keypad subsequent to receiving the acknowledge signal. Alternatively, the specified message request can be received as a signal or bit within the acknowledge signal.

For example, if the called party phone is an MS, then the acknowledge signal may be transmitted by the MS whenever one of a first group of keys is depressed, the first group comprising the “talk” or “send” button of the MS. An acknowledge signal with the signal or bit may be transmitted by the MS if the called party depresses any one of a second group of keys is depressed. For example, the second group can include a key whose defined purpose, when the MS is ringing, is to indicate a request by the called party for the specified message to be played to the calling party. After receiving the specified message request, the serving MSC prompts an IVR to play a specified message to the calling party. The specified message is to inform the calling party that the called party will be taking the call shortly.

In addition to playing a message for the calling party, a series of optional steps may be performed. Thus far, the call connection has not been modified in any way. Mainly, a message has been played to provide information to the calling party about the called party's intentions. The optional steps include placing the call on hold (step 312) and then completing the call by taking the call off hold upon the receipt of a ready indication from the called party (step 314). The ready indication may be transmitted by the called party phone and may be received in one of several formats.

For example, the ready indication may be sent by the depression of the select key/button. Alternatively, the ready indication may be sent by the called party phone upon the depression of the “talk” button on the called party phone if the called party phone is a mobile station. If the called party phone is not a mobile station, and the present invention is implemented, by way of example, in an IN, then the ready indication may be generated by, for example, the same key/button that was used by the called party to request the specified message.

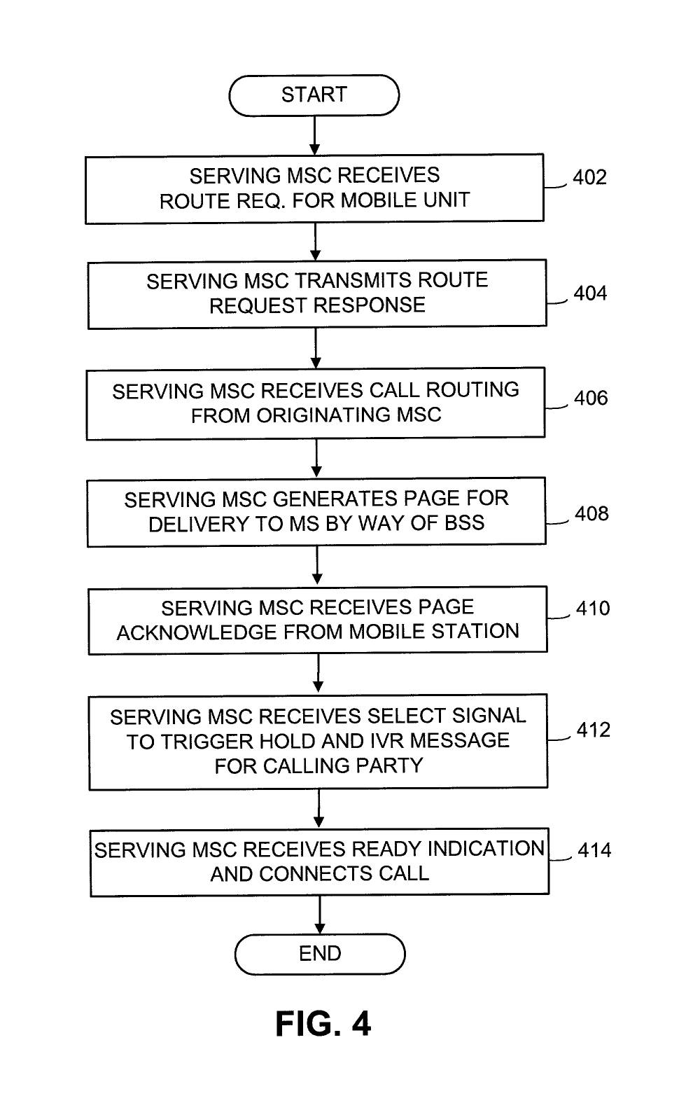

FIG. 4 is a flow chart illustrating a method in a network server for completing a call according to an embodiment of the present invention. In the described embodiment, the call server is a serving MSC and the called party phone is a mobile station. More specifically, a serving MSC receives a route request signal for the MS (step 402) and, because it is a serving MSC for the MS, it returns a route request response (step 404). The serving MSC then receives call routing from the originating MSC (step 406). Responsive thereto, the serving MSC generates a paging signal to the MS by way of a corresponding BSS serving the MS to complete the call (step 408). The serving MSC then receives a page acknowledge from the MS indicating that it is able to take the call (step 410). Thereafter, the MSC receives a select signal from the MS to prompt it to hold the call and to play a specified message to the calling party (step 412). Finally, the serving MSC receives a ready indication from the MS and completes the connection to enable the parties to communicate.

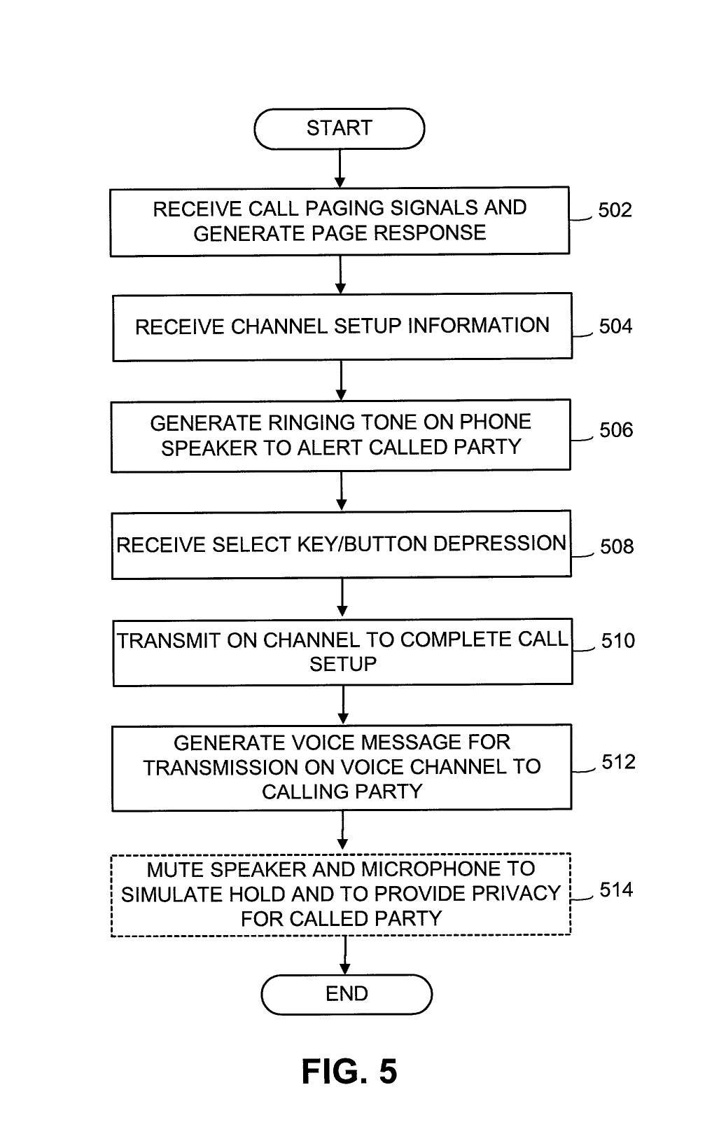

FIG. 5 is a flow chart illustrating a method in a mobile station for receiving a call and for causing a message to be played to the calling party indicating that the call will be answered shortly according to one embodiment of the present invention. Initially, the mobile station receives call-paging signals and generates a response thereto (step 502). Thereafter, the MS receives channel setup information including, for example, specific information regarding the channels for receiving and transmitting (step 504). At approximately the same time, the MS generates an alert for the called party to indicate that a call is being received (step 506). The alert can be in any known form including beeps, buzzes, vibrations and ringing sounds. During the time that the MS is in an alert producing mode, it monitors the keypad and various switches (buttons) of the MS to determine whether the called party has depressed a select keypad, button or switch indicating that he or she wishes to have the select message played to the calling party. Thus, if the called party does depress the select keypad, button, or switch, the MS receives/recognizes the same (step 508). Responsive thereto, the MS responds to indicate that it wants to accept and connect to the call to complete the call setup (step 510).

Once the call is connected, the MS generates a voice message for transmission on the voice channel to the called party to advise the calling party that the called party will be taking the call shortly (step 512). Optionally, according to system implementation, the invention further includes the step of muting the microphone to provide privacy for the called party until such time that the called party is ready to take the call (step 514). As a further optional step, the invention includes muting the speaker as well to provide equal protection to the parties and to uphold an implicit vote of privacy that a called party might have elected had he thought such a vote would have an impact.

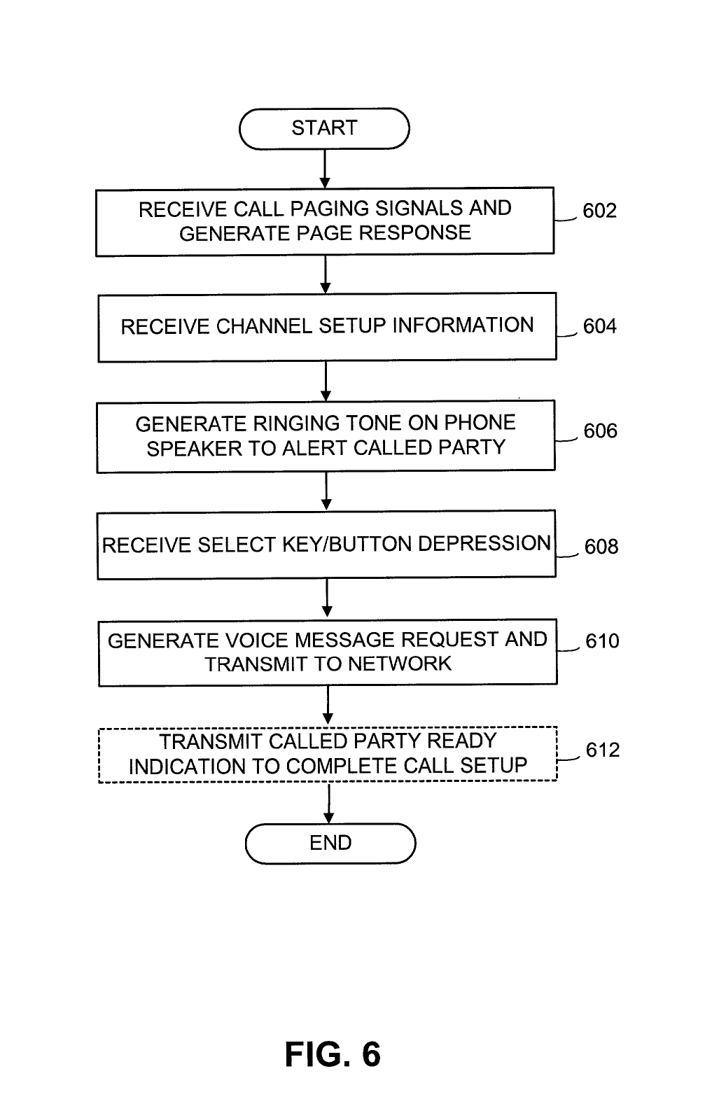

FIG. 6 is a flow chart illustrating a method in a mobile station for receiving a call and for causing a message to be played to the calling party indicating that the call will be answered shortly according to one embodiment of the present invention. Initially, the mobile station receives at least one call-paging signal and generates a response thereto (step 602). Thereafter, the MS receives channel setup information including, for example, specific information regarding the channels for receiving and transmitting (step 604). At approximately the same time, the MS generates an alert for the called party to indicate that a call is being received (step 606). The alert can be in any known form including beeps, buzzes, vibrations and ringing sounds. During the time that the MS is in an alert producing mode, it monitors the keypad and various switches (buttons) of the MS to determine whether the called party has depressed a select keypad, button or switch indicating that he or she wishes to have the select message played to the calling party. Thus, if the called party does depress the select keypad, button, or switch, the MS receives/recognizes the same (step 608). Responsive thereto, the MS generates a voice message request and transmits the same to the wireless network so that a voice message may be generated to advise the calling party that the called party will be taking the call shortly (step 610).

In one embodiment of the invention, the network, and more particularly, the MSC do not complete the call connection until the called party indicates that it is ready to take the call. Thus, for this embodiment, the called party depresses a select key, such as the “talk” or “send” keys to prompt the mobile to transmit a signal to the wireless network advising that it is ready to take the call. Thus, in this embodiment, the MS transmits a signal reflecting it is ready to complete the call once the select button has been depressed (step 612). This step is optional, however. In an alternate embodiment of the invention, the MSC waits a specified amount of time, e.g., twenty seconds before it commences completing the call. Thus, in this embodiment, the called party has the specified amount of time to go to a location that will bother others less when the call is taken.

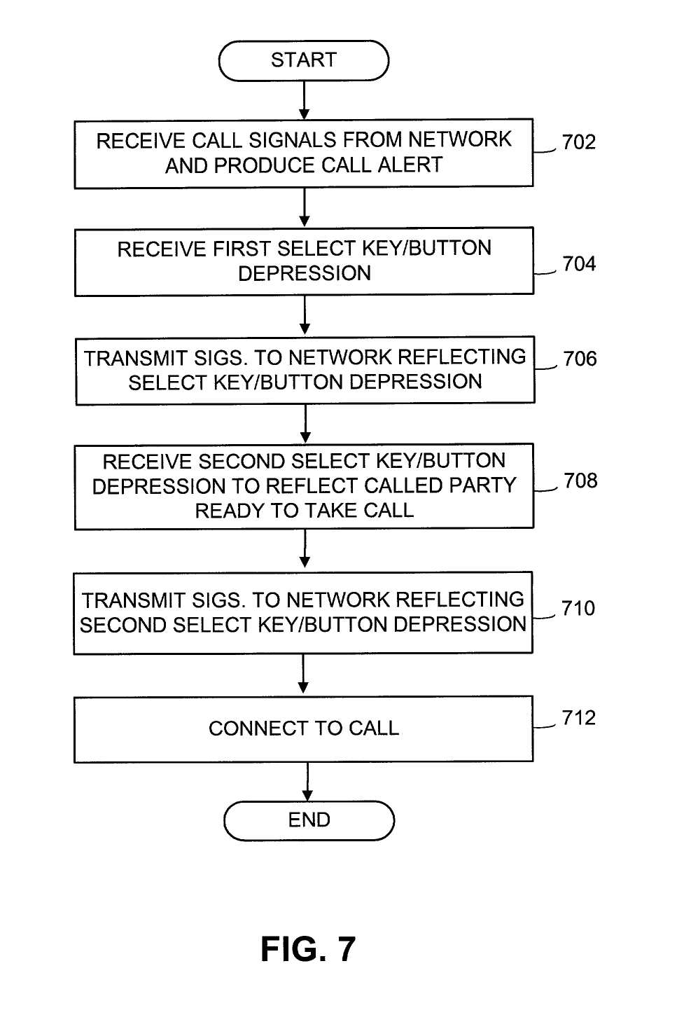

FIG. 7 is a flow chart illustrating a method in a called party phone for receiving a call and for causing a message to be played to the calling party indicating that the call will be answered shortly according to one embodiment of the present invention. The method of FIG. 7 may be performed either within a mobile station or within a wireline phone. Initially, the called party phone receives at least one call signal and, responsive thereto, produces an alert for the called party to notify the called party of the incoming call (step 702). Thereafter, the called party phone receives a first select key/button depression reflecting a called party's request for a message to be played to the calling party to indicate that the called party will answer the call shortly (step 704). In one embodiment of the present invention, the key/button depression is interpreted to signify that the called party is requesting the specified message to the calling party only if the key/button is depressed during the time that the called party is being alerted. For example, if the select key is any numerical key on the keypad, then the selection of that key while the phone is ringing (or vibrating or buzzing or beeping) to alert the user is interpreted to mean that the user wants the select message to be played to the calling party. In most, if not all, other circumstances, however, the depression of a numerical key is interpreted to mean that a number is being entered.

Upon the depression of the select key, a signal is transmitted to the network reflecting the select key/button selection (step 706). In the case of a wireline phone, a DTMF tone is transmitted as the signal. In the case of a mobile station, either a DTMF tone (or signal representing the same) is transmitted in one embodiment. In another embodiment, a select signal is transmitted to the network as a part of a defined signal. For example, a specified bit may be set to reflect the called party's action.

From the phone's perspective, the next event of interest is determining that the user is ready to accept or engage in the call. Thus, in one embodiment of the invention, the phone receives a second select key/button depression indicating that the called party is ready to accept the call (step 710). Finally, the call is connected (step 712).

While the above description assumes that the call is not connected until the called party is ready, alternative approaches may be had. For example, in one alternate embodiment, the call is connected as soon as the user selects or depresses any key/button on the phone or, if a wireline phone, removes the handset off hook. However, if, within a short and specified period of time, in the case of the wireline phone, the called party depresses a select key, the network detects the same and merely plays a voice message to inform the calling party that the called party will take the call shortly.

Similarly, for a mobile station, depression of any key may be used to prompt the mobile station to complete the call termination. However, if a select key or button is depressed, then not only is the call completed or terminated, but the system is prompted to play a message for the calling party to advise it that the called party will be taking the call shortly.

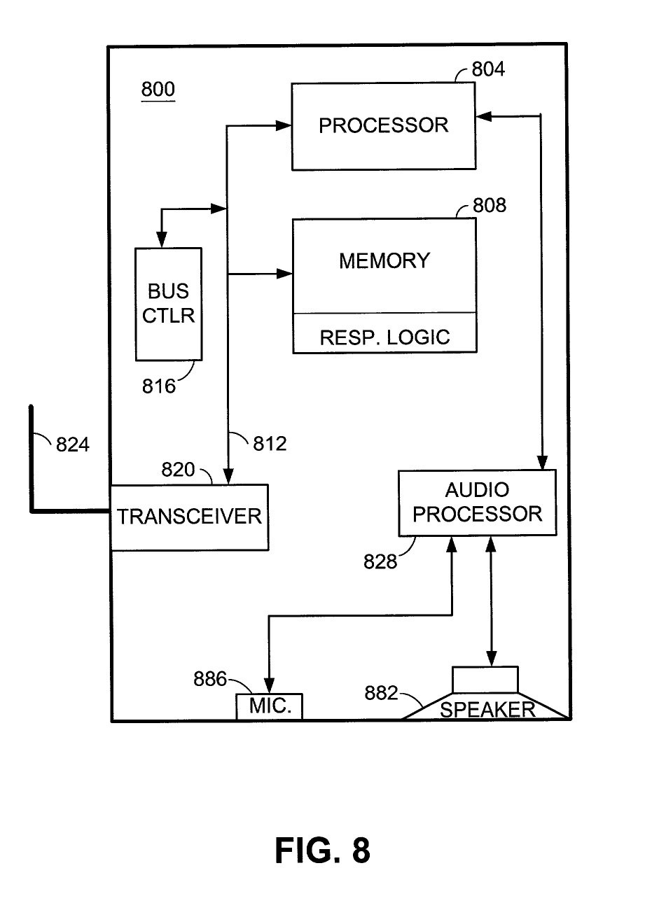

FIG. 8 is a functional block diagram of a mobile station formed according to the present invention. Mobile station 800 includes a processor 804 and a memory 808 both of which are coupled to an internal bus 812. Internal bus 812 is coupled and controlled by a bus controller 816 that controls the communications thereon bus 812. Memory 808 includes computer instructions for execution by processing unit 804, which computer instructions define the operational logic of mobile station 800. Additionally, the computer instructions stored within memory 808 define the operational characteristics of the mobile with respect to the described methods for playing a select message to the called party and, potentially for placing the calling party on hold or on a simulated hold by muting at least the phone microphone if not also the speaker.

Memory 808 further defines logic to prompt the processor 804 to cause the mobile station to operate in a conventional manner. As may also be seen, mobile station 300 further includes an audio processor 828 for processing audio received and transmitted from microphone 886 and speaker 882, respectively. Mobile station 800 further includes a transceiver 820 for receiving and transmitting communication signals over a wireless communication link. Finally, a bus controller 816 is coupled to control the timing, synchronization of bus 812 and to perform other known bus control functions.

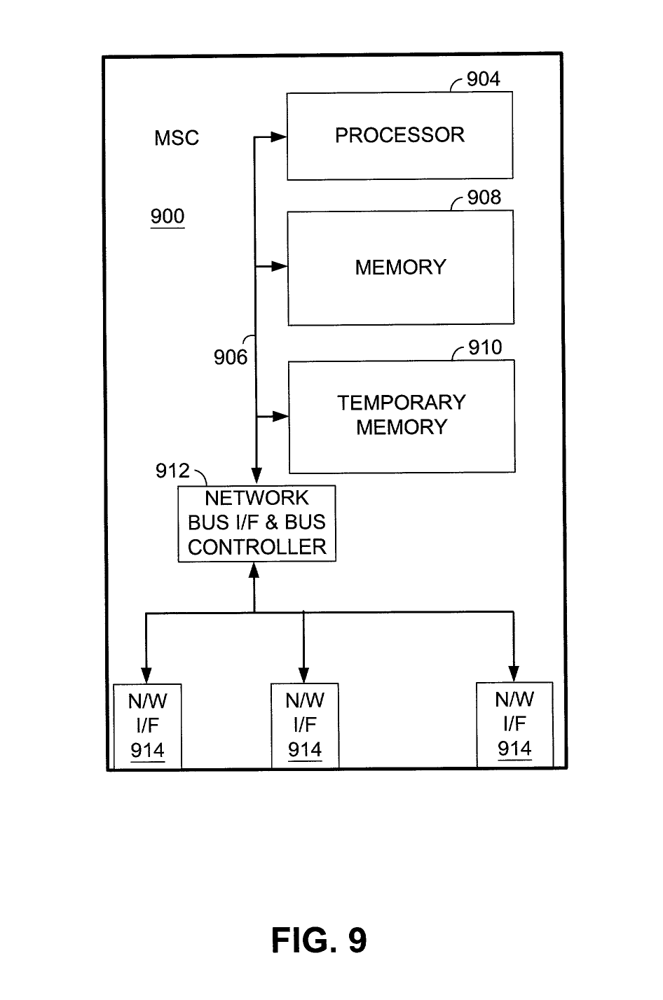

FIG. 9 is a functional block diagram of a mobile switching center formed according to one embodiment of the present invention. Referring now to FIG. 9, an MSC 900 includes a processing unit 904, a memory 908 and temporary memory 910. Each is connected to an internal bus 912. Internal bus 912 further is connected to a bus controller 916 that controls the timing, synchronization, and more generally, the bus communications on bus 912.

Memory 908 includes computer instructions that define the operational logic of MSC 900 as well as logic for generating one of a plurality of signals to request a select message from an IVR for the calling party to advise the calling party that the called party will be taking the call shortly or for actually generating the message to the calling party. In general, the computer instructions define the logic to perform any one of the process or methods described herein. Memory 908 further includes profile information and logic for obtaining profile information from an external system such as an HLR, whenever necessary and for performing ordinary MSC.

Memory 910 includes temporary memory buffers for storing operational data created or received during processing. Processing unit 904, therefore, communicates with memory 908 by way of bus 912 to receive the computer instructions and memory 910 for obtaining temporary data stored therein. Processing unit 904 then executes the computer instructions within memory 908 and operates upon the data stored within memory 910 to effectuate the operational logic defined by the computer instructions stored within memory 908. The operational logic defined by the computer instructions stored within memory 908 are described in greater detail in reference to the method and process steps described herein this application that relate to the present invention.

Bus controller 916 further is coupled to a plurality of network interface ports 920, 924 and 928 for communicating with external devices. By way of example, network interface port 920 may be for communicating over a world wide web while network interface port 924 may be for communicating over a communication network such as the Internet. Network interface port 928 also may be for communicating with networks of other types such as SS7 telephone networks. While FIG. 9 illustrates only three network ports, it is understood that the MSC of FIG. 9 is not limited to three ports and there may be a great number of ports for supporting the topology shown in FIG. 1, by way of example.

The invention disclosed herein is susceptible to various modifications and alternative forms. Specific embodiments therefor have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. For example, each process steps described herein this application or suggested herein may be implemented by software or computer instructions stored in memory and executed by a processor coupled to receive the computer instructions or may be implemented in logic defined within hardware as is known by those skilled in the art. Moreover, the process steps may be implemented as described or in an alternate form in any of the known types of phones systems and phone types including PBX, wireline, cordless wireless and cellular mobile stations.

1. A mobile switching center (MSC), comprising:
a processor;
an internal bus coupled to the processor; and
a memory for storing computer instructions, which computer instructions define operational logic of the MSC and more particularly, logic for receiving and responding to a request by a called party user of a mobile station for a message to be played to a calling party to advise the calling party that the called party will be taking the call shortly.

2. The MSC of claim 1 wherein the computer instructions further define logic to prompt the MSC to prompt an IVR to play a specified message to the calling party.

3. The MSC of claim 2 wherein the computer instructions further define logic to prompt the MSC to place the calling party on hold.

4. The MSC of claim 2 wherein the computer instructions further define logic to prompt the MSC place the calling party on hold until the MSC receives a ready indication from the called party.

5. The MSC of claim 2 wherein the computer instructions further define logic to prompt the MSC place the calling party on hold until a specified amount of time has elapsed.

6. The MSC of claim 5 wherein the specified amount of time is less than one minute.

7. The MSC of claim 5 wherein the specified amount of time is approximately equal to twenty seconds.

8. The MSC of claim 2 wherein the computer instructions define logic to complete the call setup and, as soon as the call is setup, prompting the IVR to play the specified message.

9. A system for connecting a calling party to a called party, comprising:
circuitry including logic for receiving and interpreting a call request from a calling party;
circuitry including logic for determining the identity of a communications node to which a call set up signal is to be routed as a part of establishing a call between the called and the calling parties; and
circuitry including logic for responding to a select indication made upon a called party phone, which select indication is a request for a specified message to be played to the calling party to advise the calling party that the called party will be taking the call shortly.

10. The system of claim 9 wherein the circuitry including logic for responding further includes logic for responding to a select indication that the called party is ready to take the call.

11. The system of claim 10 wherein the circuitry responds by connecting the call upon received the select indication that the called party is ready to take the call.

12. The system of claim 9 wherein the select indication for a specified message to be played is received in the form of DTMF tones.

13. The system of claim 9 wherein the select indication for a specified message to be played is received in the form of a select DTMF tone, which select DTMF tone must be received within a specified time frame triggered by on of receiving an “off hook” indication or, in the case of a wireless network, a call acceptance indication.

14. The system of claim 9 wherein the select indication for a specified message to be played is received in the form of a defined signal within a defined response signal.

15. The system of claim 9 wherein the circuitry further includes logic to cause the call to be connected immediately after receiving the select indication that is a request for a specified message to be played to the calling party.

16. A method for connecting a call placed by a calling party to a called party, comprising:
receiving an indication that a call is to be setup with the called party;
receiving an indication of the called party number;
determining a serving node for the called party;
transmitting call set up signals to the serving node;
responding to a called party response by triggering an IVR to play a select message to the calling party to advise the calling party that the called party will be taking the call shortly.

17. The method of claim 16 further including the step of connecting the call without waiting for a ready indication to connect the call.

18. The method of claim 16 further including the step of waiting for a ready indication transmitted by the called party phone prior to connecting the call.

19. The method of claim 16 wherein the call is connected after a specified period of time has elapsed since the called party response including a request was received.

20. The method of claim 16 wherein the called party response including a request is received in the form of a select DTMF tone within a specified period of time since the transmission of a call setup signal to the called party phone.

21. The method of claim 16 further comprising the step of advising the calling party of a sequence of steps that the calling party may take to leave a message.

22. The method of claim 16 further including the step of re-entering into an alert mode of operation.

23. The method of claim 22 wherein the step of re-entering into an alert mode of operation occurs only upon activation by the calling party.

24. The method of claim 22 wherein the step of re-entering into an alert mode of operation occurs automatically after the expiration of a specified amount of time.
